(19) United States
(12) Patent Application Publication
(10) Pub. No.: US 2018/0196578 A1
(43) Pub. Date: Jul. 12, 2018

(54) Method and Device for Identifying Java Window Control

(71) Applicant: ZTE CORPORATION, Shenzhen City, Guangdong Province (CN)

(72) Inventors: Lei JIANG, Shenzhen (CN); Jian ZHANG, Shenzhen (CN); Guangyao PENG, Shenzhen (CN); Yu MEI, Shenzhen (CN)

(21) Appl. No.: 15/743,679

(22) PCT Filed: Nov. 18, 2015
(86) PCT No.: PCT/CN2015/094910

§ 371 Date: Jan. 11, 2018

(30) Foreign Application Priority Data
Jul. 21, 2015 (CN) 201510428900.0

(51) Int. Cl. G06F 3/0481; G06F 9/451

(52) U.S. Cl. CPC G06F 3/0481; G06F 9/451

(57) ABSTRACT

Provided are a method and device for identifying a java window control. The method includes: acquiring attribute information of all controls in a current java window, herein the attribute information of the controls includes position information of the controls; acquiring position information of current location; and determining a target control of the current location according to the position information of the current location and the position information of all controls.

### TECHNICAL FIELD

This document relates to but is not limited to the field of computer technology, in particular to a method and device for identifying a java window control, and a computer-readable storage medium.

### BACKGROUND

In a Windows operating system, most programs have windows, there are different controls such as input edit boxes and buttons on the windows, and these controls are generally called as heavyweight controls, each of which is essentially a window having a window handle capable of making a response to messages from a Windows mouse, a keyboard and the like.

Microsoft provides a utility spy++, which can accurately recognize a window control of a target program. However, for a window of a java program running on the Windows operating system, neither spy++ provided by Microsoft nor a window identification program written based on an API interface provided by Microsoft can effectively identify control information on a java window. The utility spy++ can only discover the java window but cannot identify controls because the controls on the java window are not Windows controls although the java window is a Windows window, i.e., they are not Windows windows, do not have window handles and essentially are controls drawn according to java draw primitives, i.e., lightweight controls, and responses to message events of mice, keyboards and the like of Windows are realized in java.

### SUMMARY

The following is a summary of the subject described in detail in this text. This summary is not used for limiting the protection scope of the claims.

The embodiment of the present disclosure provides a method and device for identifying a java window control and a computer-readable storage medium, aiming at solving the problem that java window controls cannot be identified based on a Windows operating system.

A method for identifying a java window control includes:

acquiring attribute information of all controls in a current java window, herein the attribute information of the controls includes position information of all controls;

acquiring position information of current location; and

determining a target control of the current location according to the position information of the current location and the position information of all controls.

In an exemplary embodiment, the step of acquiring the attribute information of all controls in a current java window includes:

acquiring draw primitives of all controls in the current java window from a current java process; and

acquiring the attribute information of the controls from the draw primitives.

In an exemplary embodiment, the attribute information of the controls further includes type information of the controls.

In an exemplary embodiment, the step of acquiring the position information of the current location includes:

acquiring position information of a position where a current mouse cursor is located.

In an exemplary embodiment, the step of determining a target control of the current location according to the position information of the current location and the position information of all controls includes:

determining a control with position information containing the position information of the current location in the position information of all controls as the target control corresponding to the current location.

In an exemplary embodiment, after the step of determining a target control corresponding to the current location, the method for identifying the java window further includes:

displaying the target control in a reminding manner and displaying attribute information of the target control.

In an exemplary embodiment, the target control is displayed in a highlight display manner or the target control is displayed in a coloring manner.

The embodiment of the present disclosure further provides a device for identifying a java window control, including:

an attribute acquisition module configured to acquire attribute information of all controls in a current java window, herein the attribute information of the controls includes position information of all controls;

a position acquisition module configured to acquire position information of current location; and

a location module configured to determine a target control of the current location according to the position information of the current location and the position information of all controls.

In an exemplary embodiment, the attribute acquisition module includes:

a first acquisition submodule configured to acquire draw primitives of all controls in the current java window from a current java process; and

a second acquisition submodule configured to acquire the attribute information of the controls from the draw primitives.

In an exemplary embodiment, the device further includes:

a reminding module configured to, after the location module determines the target control corresponding to of the current location, display the target control in a reminding manner and display attribute information of the target control.

The embodiment of the present disclosure further provides a computer-readable storage medium, storing program instructions, which, when executed by a processor, are capable of implementing the method for identifying a java window control provided by the embodiment of the present disclosure.

The above-mentioned solution of the present disclosure at least has the following beneficial effects:

In the method and device for identifying a java window control provided by the present disclosure, by determining the corresponding control in the java window according to the position information, the java window control can be effectively identified and displayed based on the Windows operating system, and a great convenience is provided for the operation based on the java process.

After the drawings and detailed description are read and understood, other aspects can be understood.

### BRIEF DESCRIPTION OF DRAWINGS

FIG. 1 illustrates a flowchart of a method for identifying a java window control according to an embodiment of the present disclosure.

FIG. 2 illustrates a structural schematic diagram of a device for identifying a java window control according to an embodiment of the present disclosure.

FIG. 3 illustrates a schematic view of a scenario according to an embodiment of the present disclosure.

### DETAILED DESCRIPTION

In order to make the problem to be solved by the present disclosure, the solution and the advantages clearer, the present disclosure will be described below in detail with reference to the drawings in combination with the specific embodiments.

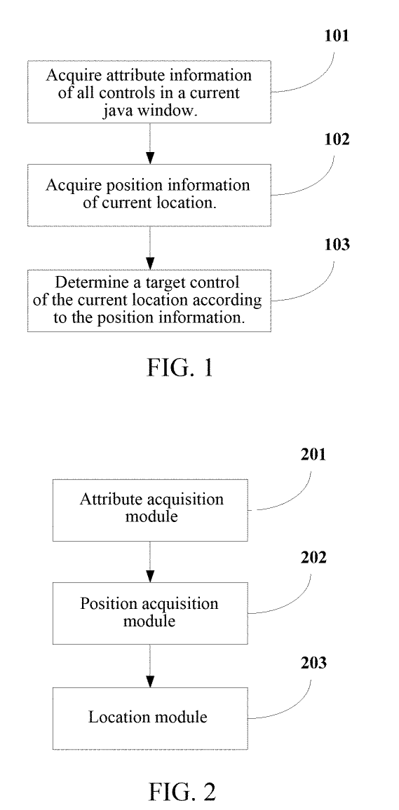

Referring to FIG. 1, an embodiment of the present disclosure provides a method for identifying a java window control. The method includes the following steps.

In step 101, attribute information of all controls in a current java window is acquired, herein the attribute information of the controls includes position information of all controls.

In the embodiment, step 101 may include:

acquiring draw primitives of all controls in the current java window from a current java process; and

acquiring the attribute information of the controls from the draw primitives.

In other words, an interception code is embedded into a java process to intercept draw primitives of all controls in the current java window, and the draw primitive includes a plurality of instructions for drawing the control; and then attribute information of each control is acquired from the relevant draw primitive.

In the embodiment, the attribute information may further include type information of the control. Herein, the type information may be a button, an edit input box or the like.

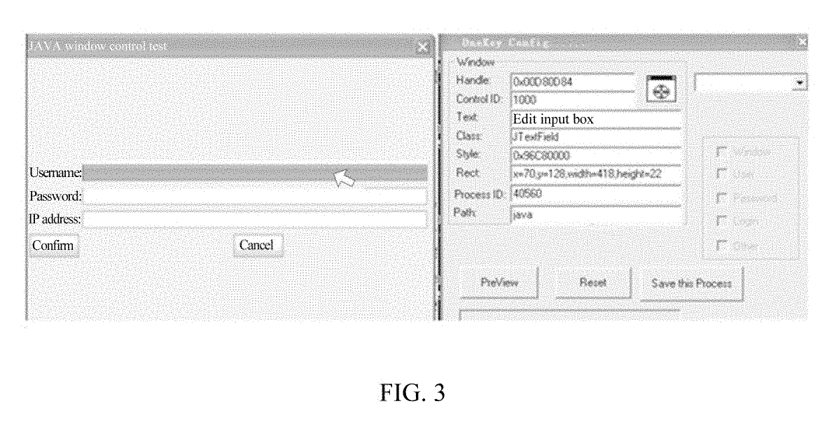

Referring to FIG. 3, as one embodiment of the present disclosure, controls in the current java window include: an edit input box corresponding to “Username”, an edit input box corresponding to “Password”, an edit input box corresponding to “IP address” and buttons “Confirm” and “Cancel”. Firstly an interception code is embedded into a java process to acquire draw primitives of the controls, and attribute information of all controls is acquired from the draw primitive; and the attribute information includes position information of controls, type information of controls and the like. For example, as illustrated in FIG. 3, the position information of the edit input box corresponding to “Username” is as follow: a horizontal position coordinate of a left upper corner start point of the control is 10, a vertical position coordinate is 120, width of the control is 400 and height is 30; the position information of the edit input box corresponding to “Password” is as follow: a horizontal position coordinate of a left upper corner start point of the control is 10, a vertical position coordinate is 155, width of the control is 400 and height is 30.

Continuously referring to FIG. 1, in step 102, position information of current location is acquired.

Herein, step 102 includes: acquiring position information of a position where a current mouse cursor is located. Referring to FIG. 3, the position where the current mouse cursor is located is horizontal position x=70, vertical position y=128.

Continuously referring to FIG. 1, in step 103, a target control of the current location is determined according to the position information of the current location and the position information of all controls.

Herein, the position information of the current location is the position where the current mouse cursor is located, acquired in step 102.

Herein, step 103 includes: determining a target control corresponding to the current location according to the position information, including:

matching the position information of the current location with the position information of all controls, and when position information of a control contains the position information of the current location, determining the control as the target control.

From the position information of all controls acquired in step 101, a control with position information being the same as the position information of the current location acquired in step 102 is determined as the target control; and for example, in the java window as illustrated in FIG. 3, according to the acquired position information of all controls in the java window, it is determined that the position where the current mouse cursor is located is the position of the edit input box corresponding to “Username”, i.e., the target control is determined to be the edit input box corresponding to “Username”.

In the embodiment, after the step of determining the target control of the current location, the method for identifying the java window may further include: displaying the target control in a reminding manner and displaying attribute information of the target control at the same time. In the embodiment, the target control may be displayed in a highlight display manner or displayed in a coloring manner.

Referring to FIG. 3, a left window therein is a java window. When it is determined that the edit input box corresponding to “Username” is the target control, the target control is colored and the attribute information of the target control in a right window is displayed, herein the attribute information includes handle, control ID, text, class, etc.

In the method and device for identifying a java window control provided by the embodiment of the present disclosure, by determining the corresponding control in the java window according to the position information, the java window control can be effectively identified and displayed based on the Windows operating system, and a great convenience is provided for the operation based on the java process.

Referring to FIG. 2, the embodiment of the present disclosure further provides a device for identifying a java window control. The device includes:

an attribute acquisition module 201 configured to acquire attribute information of all controls in a current java window, herein the attribute information of the controls includes position information of all controls;

a position acquisition module 202 configured to acquire position information of current location; and

a location module 203 configured to determine a target control corresponding to the current location according to the position information of the current location and the position information of all controls.

Herein, the attribute acquisition module 201 includes:

a first acquisition submodule configured to acquire a draw primitives of all controls in the current java window from a current java process; and

a second acquisition submodule configured to acquire the attribute information of the controls from the draw primitives.

In the embodiment, the device may further include:

a reminding module configured to, after the location module 203 determines the target control corresponding to the current location, display the target control in a reminding manner and display attribute information of the target control.

The embodiment of the present disclosure further provides a computer-readable storage medium, storing program instructions, which, when executed by a processor, are capable of implementing the method for identifying a java window control provided by the embodiment of the present disclosure.

One skilled in the art can understand that all or partial steps in the above-mentioned embodiments may be implemented by using a computer program process, the computer program may be stored in a computer-readable storage medium, the computer program is executed on a corresponding hardware platform (e.g., a system, equipment, an apparatus or a device), and when being executed, it includes one or combinations of the steps of the method embodiments.

Alternatively, all or partial steps in the above-mentioned embodiments may also be implemented by using integrated circuits, and these steps may be respectively manufactured into integrated circuit modules, or more modules or steps thereof may be manufactured into a single integrated circuit module to implement.

Each device/function module/function unit in the above-mentioned embodiments may be implemented by adopting a general-purpose computing device, and they may be integrated on a single computing device and may also be distributed on a network consisting of multiple computing devices.

When each device/function module/function unit in the above-mentioned embodiments is implemented by means of software function module and is sold or used as an independent product, it may be stored in a computer-readable storage medium. The above-mentioned computer-readable storage medium may be a read-only memory, a magnetic disk, a compact disk or the like.

### INDUSTRIAL APPLICABILITY

In the method and device for identifying a java window control provided by the present disclosure, by determining the corresponding control in the java window according to the position information, the java window control can be effectively identified and displayed based on the Windows operating system, and a great convenience is provided for the operation based on the java process.

What is claimed is:

1. A method for identifying a java window control, comprising:
acquiring attribute information of all controls in a current java window, wherein the attribute information of the controls comprises position information of all controls;
acquiring position information of current location; and
determining a target control corresponding to the current location according to the position information of the current location and the position information of all controls.

2. The method for identifying the java window control according to claim 1, wherein the step of acquiring attribute information of all controls in a current java window comprises:
acquiring draw primitives of all controls in the current java window from a current java process; and
acquiring the attribute information of the controls from the draw primitives.

3. The method for identifying the java window control according to claim 2, wherein the attribute information of the controls further comprises type information of the controls.

4. The method for identifying the java window control according to claim 1, wherein the step of acquiring position information of current location comprises:
acquiring position information of a position where a current mouse cursor is located.

5. The method for identifying the java window control according to claim 1, wherein the step of determining a target control of the current location according to the position information of the current location and the position information of all controls comprises:
matching the position information of the current location with the position information of all controls, and when position information of a control contains the position information of the current location, determining the control as the target control of the current location.

6. The method for identifying the java window control according to claim 1, wherein, after the step of determining a target control corresponding to the current location, the method further comprises:
displaying the target control in a reminding manner and displaying attribute information of the target control.

7. The method for identifying the java window control according to claim 6, wherein the step of displaying the target control in a reminding manner comprises:
displaying the target control in a highlight display manner or displaying the target control in a coloring manner.

8. A device for identifying a java window control, comprising:
an attribute acquisition module configured to acquire attribute information of all controls in a current java window, wherein the attribute information of the controls comprises position information of all controls;
a position acquisition module configured to acquire position information of current location; and
a location module configured to determine a target control corresponding to the current location according to the position information of the current location and the position information of all controls.

9. The device for identifying the java window control according to claim 8, wherein the attribute acquisition module comprises:
a first acquisition submodule configured to acquire draw primitives of all controls in the current java window from a current java process; and
a second acquisition submodule configured to acquire the attribute information of the controls from the draw primitives.

10. The device for identifying the java window control according to claim 8, wherein the device further comprises:
a reminding module configured to, after the location module determines the target control corresponding to the current location, display the target control in a reminding manner and display attribute information of the target control.

11. A computer-readable storage medium, storing program instructions, which, when executed by a processor, implement the method according to claim 1.
